(19) United States
(12) Patent Application Publication
(10) Pub. No.: US 2025/0215667 A1
(43) Pub. Date: Jul. 3, 2025

(54) EXCAVATOR AND EXCAVATOR CONTROL SYSTEM

(71) Applicant: SUMITOMO CONSTRUCTION MACHINERY CO., LTD., Tokyo (JP)

(72) Inventor: Yuiki MATSUHASHI, Chiba (JP)

(21) Appl. No.: 18/978,487

(22) Filed: Dec. 12, 2024

(30) Foreign Application Priority Data
Dec. 28, 2023 (JP) 2023-223040

(51) Int. Cl. E02F 9/26; G06T 7/00

(52) U.S. Cl. CPC E02F 9/261; G06T 7/0008

(57) ABSTRACT

An excavator includes a lower traveling body; an upper slewing body that is slewably mounted on the lower traveling body; a photographing device that is attached to the upper slewing body; a display device configured to display photographed image data that is obtained by the photographing device; and a control device configured to, in response to receiving an operation to designate an object included in the photographed image data, perform, on information indicating the object, a setting to suppress detection of the object.

### CROSS-REFERENCE TO RELATED APPLICATIONS

This application is based upon and claims priority to Japanese Patent Application No. 2023-223040, filed on Dec. 28, 2023, the entire contents of which are incorporated herein by reference.

### BACKGROUND

### 1. Technical Field

The present disclosure relates to an excavator and an excavator control system.

### 2. Description of Related Art

Techniques of monitoring the surroundings of an excavator by detecting objects existing around the excavator are proposed.

### SUMMARY

An excavator according to an aspect of the present disclosure includes: a lower traveling body; an upper slewing body that is slewably mounted on the lower traveling body; a photographing device that is attached to the upper slewing body; a display device configured to display photographed image data that is obtained by the photographing device; and a control device configured to, in response to receiving an operation to designate an object included in the photographed image data, perform, on information indicating the object, a setting to suppress detection of the object.

### BRIEF DESCRIPTION OF THE DRAWINGS

FIG. 1 is a side view illustrating an example of an excavator according to one embodiment;

FIG. 2 is a top view illustrating an example of the excavator according to the one embodiment;

FIG. 3 is a diagram illustrating a configuration example of a drive control system of the excavator according to the one embodiment;

FIG. 4 is a functional block diagram illustrating a configuration example of a controller of the excavator according to the one embodiment;

FIG. 5 is a view illustrating an example of an input device and a display screen displayed by a first display device according to the one embodiment;

FIG. 6 is a view illustrating a transition in a rearward image disposed in a second image display section under control of a controller and the first display device according to the one embodiment;

FIG. 7 is a flowchart illustrating a setting procedure through which the controller and the first display device according to the one embodiment suppress detection of an object;

FIG. 8 is a flowchart illustrating a processing procedure in performing a determination using an object storage database when the controller and the first display device according to the one embodiment display photographed image data;

FIG. 9 is a side view illustrating an example of an excavator according to another embodiment;

FIG. 10 is a schematic view illustrating an example of an excavator control system according to yet another embodiment;

FIG. 11 is a sequence diagram illustrating a setting procedure for suppressing detection of an object in the excavator control system according to the yet another embodiment; and

FIG. 12 is a sequence diagram illustrating a processing procedure in a case of performing a determination using an object storage database when the excavator control system according to the yet another embodiment displays photographed image data.

### DETAILED DESCRIPTION

A technique of using a stereo camera to detect objects existing around a work machine is described. However, when objects are detected using a detection device, such as a stereo camera or the like, an error may occur in detection results of the objects. When information in accordance with false detection results is output, an operator or the like may feel inconvenienced by the output information.

One aspect of the present disclosure proposes a technique of achieving an improvement in detection accuracy by enabling correction of detection results by an operation.

Hereinafter, embodiments of the present disclosure will be described with reference to the drawings. The embodiments as described below do not limit the present disclosure but are illustrative. All of the features described in the embodiments and combinations of the features are not necessarily essential to the present disclosure. Throughout the drawings, the same or corresponding components are denoted by the same or corresponding symbols, and description may be omitted.

In the following, the embodiments of the present disclosure will be described with examples in which an excavator is used as an example of a work machine. However, the present disclosure does not limit the work machine to an excavator. The present disclosure may be applicable to a construction machine, a standard machine, an applied machine, a forestry machine, or a conveyance machine based on a hydraulic excavator.

### One Embodiment

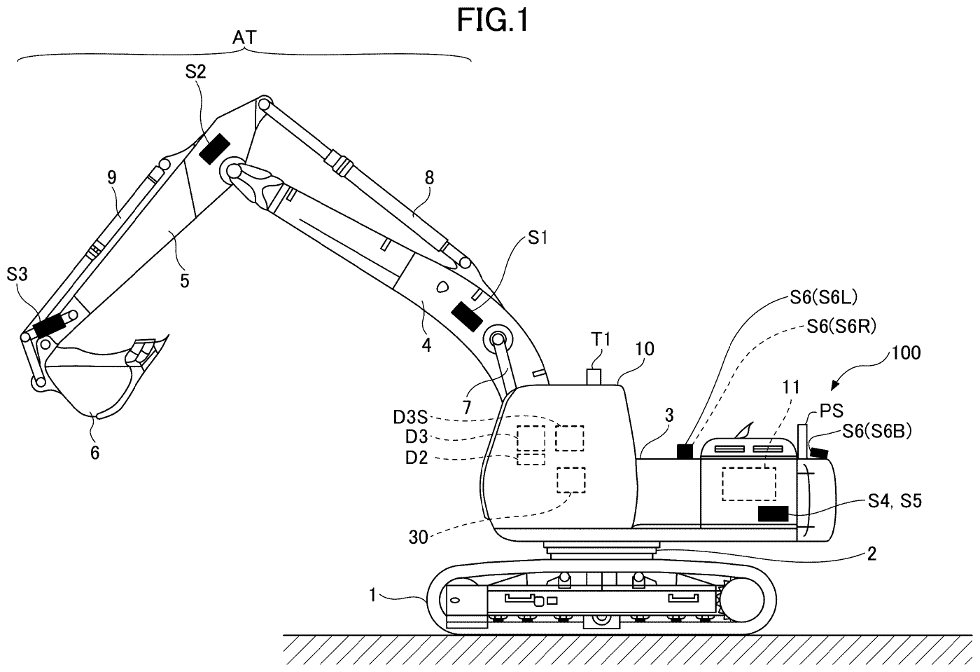

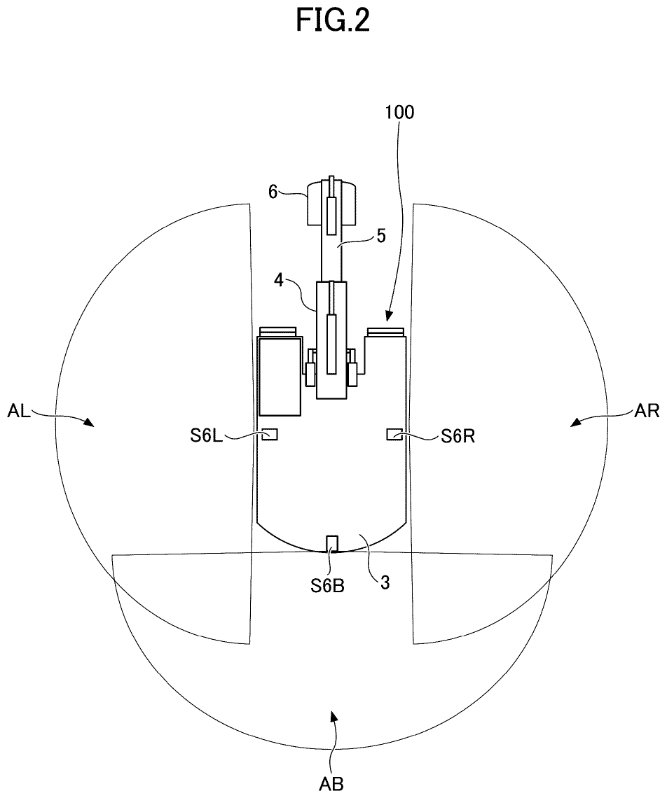

First, an outline of an excavator 100 according to the present embodiment will be described with reference to FIG. 1. FIG. 1 is a side view of the excavator 100 according to the one embodiment. FIG. 2 is a top view of the excavator 100 according to the one embodiment.

An upper slewing body 3 is slewably mounted via a slewing mechanism 2 to a lower traveling body 1 of the excavator 100. A boom 4 is attached to the upper slewing body 3. An arm 5 is attached to an end of the boom 4. A bucket 6, which is an end attachment, is attached to an end of the arm 5. The end attachment may be, for example, a bucket for slope formation or a bucket for dredging.

The boom 4, the arm 5, and the bucket 6 form an excavating attachment, which is one example of an attachment AT. The boom 4, the arm 5, and the bucket 6 are hydraulically driven by a boom cylinder 7, an arm cylinder 8, and a bucket cylinder 9, respectively. A boom angle sensor S1 is attached to the boom 4, an arm angle sensor S2 is attached to the arm 5, and a bucket angle sensor S3 is attached to the bucket 6. The excavating attachment may be provided with a bucket tilt mechanism.

The boom angle sensor S1 is configured to detect a rotation angle of the boom 4. In the present embodiment, the boom angle sensor S1 is an acceleration sensor, and can detect a boom angle that is the rotation angle of the boom 4 with respect to the upper slewing body 3. The boom angle is, for example, the minimum angle when the boom 4 is moved down to the lowest position, and the boom angle increases as the boom 4 is raised.

The boom angle sensor S1 may include, for example, a rotary encoder, an acceleration sensor, a 6-axis sensor, an inertial measurement unit (IMU), and the like. Also, the boom angle sensor S1 may include a potentiometer using a variable resistor, a cylinder stroke sensor configured to detect the amount of stroke of a hydraulic cylinder (the boom cylinder 7) corresponding to the boom angle, and the like. The same applies to the arm angle sensor S2, the bucket angle sensor S3, and a machine body tilt sensor S4. A detection signal corresponding to the boom angle obtained by the boom angle sensor S1 is taken into a controller 30.

The arm angle sensor S2 is configured to detect a rotation angle of the arm 5. In the present embodiment, the arm angle sensor S2 is an acceleration sensor, and can detect an arm angle that is the rotation angle of the arm 5 with respect to the boom 4. The arm angle is, for example, the minimum angle when the arm 5 is closed at most, and the arm angle increases as the arm 5 is opened.

The bucket angle sensor S3 is configured to detect a rotation angle of the bucket 6. In the present embodiment, the bucket angle sensor S3 is an acceleration sensor, and can detect a bucket angle that is the rotation angle of the bucket 6 with respect to the arm 5. The bucket angle is, for example, the minimum angle when the bucket 6 is closed at most, and the bucket angle increases as the bucket 6 is opened.

The boom angle sensor S1, the arm angle sensor S2, and the bucket angle sensor S3 may each be, for example, a potentiometer using a variable resistor, a stroke sensor that detects a stroke amount of a corresponding hydraulic cylinder, or a rotary encoder that detects the rotation angle about a coupling pin. The boom angle sensor S1, the arm angle sensor S2, and the bucket angle sensor S3 form a posture sensor configured to detect a posture of the excavating attachment.

A cab 10, which is an operation room, is provided in the upper slewing body 3 and a power source such as an engine 11 is mounted to the upper slewing body 3. Also, the machine body tilt sensor S4, a slewing angle sensor S5, and a photographing device S6 are attached to the upper slewing body 3. Also, a communication device T1 and a positioning device PS are attached to the upper slewing body 3.

The machine body tilt sensor S4 is configured to detect the tilt of the upper slewing body 3 with respect to a predetermined flat plane. In the present embodiment, the machine body tilt sensor S4 is an acceleration sensor that detects the tilting angle, with respect to the horizontal surface, about the front-rear axis of the upper slewing body 3 and the tilting angle about the left-right axis of the upper slewing body 3. The front-rear axis and the left-right axis of the upper slewing body 3 are orthogonal to each other at the center point of the excavator, which is a point on the slewing axis of the excavator 100, for example.

The slewing angle sensor S5 is configured to detect a slewing angular velocity of the upper slewing body 3. In the present embodiment, the slewing angle sensor S5 is a gyro sensor. The slewing angle sensor S5 may be a resolver, a rotary encoder, or the like. The slewing angle sensor S5 may detect a slewing velocity. The slewing velocity may be calculated from the slewing angular velocity.

When the machine body tilt sensor S4 includes a gyro sensor configured to detect an angular velocity around three axes, a 6-axis sensor, an IMU, or the like, a slewing state (e.g. a slewing angular velocity) of the upper slewing body 3 may be detected in accordance with a detection signal of the machine body tilt sensor S4. In this case, the slewing angle sensor S5 may be omitted.

The photographing device S6 is configured to obtain an image around the excavator 100. In the present embodiment, the photographing device S6 includes a left camera S6L configured to photograph a space leftward of the excavator 100, a right camera S6R configured to photograph a space rightward of the excavator 100, and a rear camera S6B configured to photograph a space rearward of the excavator 100.

The photographing device S6 is, for example, a monocular camera having a photographing element, such as a CCD, a CMOS, or the like, and outputs a photographed image to a first display device D3 via the controller 30.

An input device D2 is configured to receive an operation input from an operator, and output the input operation to the controller 30. The input device D2 includes, for example, a hardware operation unit, such as a touch panel, a touch pad, a button, a toggle, a rotary knob, or the like. Also, the input device D2 may include, for example, a software operation unit operable by a hardware operation unit, such as an imaginary button icon on an operation screen displayed on the first display device D3 or the like.

As illustrated in FIG. 2, the left camera S6L is attached to the left end of the upper surface of the upper slewing body 3. The right camera S6R is attached to the right end of the upper surface of the upper slewing body 3. The rear camera S6B is attached to the rear end of the upper surface of the upper slewing body 3.

The rear camera S6B, the left camera S6L, and the right camera S6R are attached to the upper slewing body 3 such that optical axes are oriented obliquely downward and parts of the upper slewing body 3 are included in the photographing ranges. Therefore, the photographing range of each of the rear camera S6B, the left camera S6L, and the right camera S6R has, for example, a viewing angle of about 180 degrees in a top plan view. In the example of FIG. 2, a photographing range AB is an example of the photographing range of the rear camera S6B, a photographing range AL is an example of the photographing range of the left camera S6L, and a photographing range AR is an example of the photographing range of the right camera S6R. Desirably, as illustrated in FIG. 2, the three monocular cameras are attached to the upper slewing body 3 so as to be situated without extending beyond the upper surface of the upper slewing body 3.

In the present embodiment, by providing the photographing devices S6 in the above-described arrangement, the objects existing around the excavator 100 can be photographed. The present embodiment does not limit the number of the photographing devices S6 provided to the upper slewing body 3. The number of the photographing devices S6 provided to the upper slewing body 3 may be two or less or may be four or more. In the latter case, a front camera may be provided, for example, on the upper surface of the cab 10 of the upper slewing body 3. The front camera may photograph, for example, a predetermined photographing range frontward of the upper slewing body 3.

The positioning device PS is configured to obtain information about the position of the excavator 100. In the present embodiment, the positioning device PS is configured to measure the position and the orientation of the excavator 100. Specifically, the positioning device PS is a global navigation satellite system (GNSS) receiver including an electronic compass, and is configured to measure the latitude, the longitude, and the altitude of the current position of the excavator 100, and the orientation of the excavator 100.

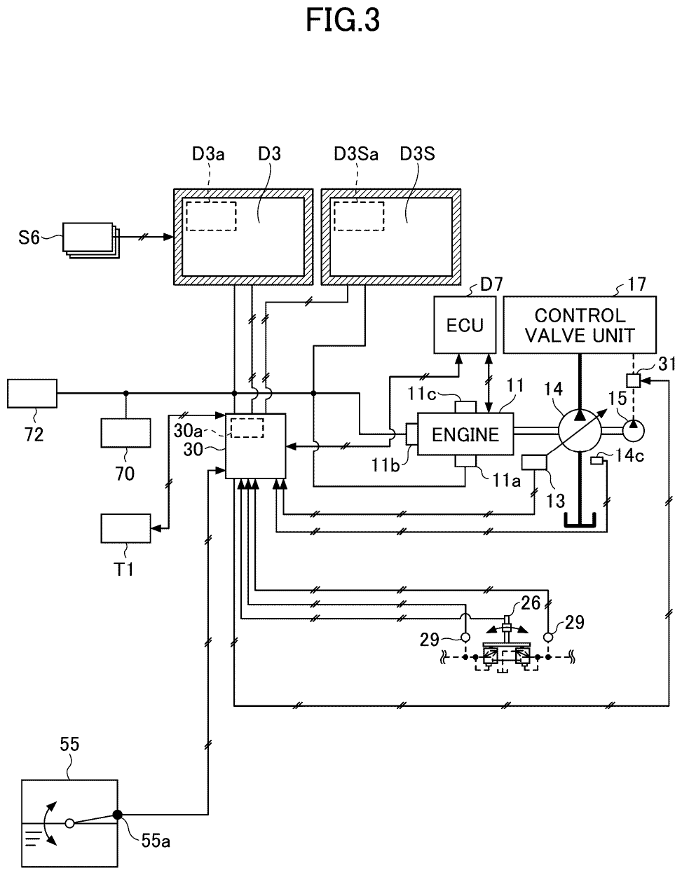

FIG. 3 is a diagram illustrating a configuration example of a drive control system of the excavator 100 of FIG. 1. In FIG. 3, a mechanical power transmission system is denoted by a double line, a hydraulic oil line is denoted by a thick solid line, a pilot line is denoted by a dashed line, and an electric drive control system is denoted by a thin solid line.

The engine 11 is a power source of the excavator 100. In the present embodiment, the engine 11 is a diesel engine employing isochronous control that keeps the rotation speed of the engine constant regardless of an increase or decrease in load applied to the engine. The amount of fuel injected, the timing of fuel injection, the boost pressure, and the like, in the engine 11 are controlled by an engine controller unit (ECU) D7.

The rotating shaft of the engine 11 is connected to the rotating shafts of a main pump 14 and a pilot pump 15, which are hydraulic pumps. A control valve unit 17 is connected to the main pump 14 via the hydraulic oil line.

The control valve unit 17 is a hydraulic control device configured to control the hydraulic system of the excavator 100. Hydraulic actuators, such as right and left hydraulic motors for traveling, the boom cylinder 7, the arm cylinder 8, the bucket cylinder 9, a hydraulic motor for slewing, and the like, are connected to the control valve unit 17 via the hydraulic oil line. The hydraulic motor for slewing may be a motor generator for slewing.

FIG. 3 is a diagram illustrating how the controller 30 is connected to the first display device D3 and a second display device D3S. In the present embodiment, the first display device D3 and the second display device D3S are connected to the controller 30. The first display device D3, the second display device D3S, and the controller 30 may be connected via a communication network, such as CAN or the like.

The first display device D3 includes a control part D3a configured to generate an image. In the present embodiment, the control part D3a generates a camera image for display in accordance with an output from a camera, which is the photographing device S6. The photographing device S6 is connected to the first display device D3, for example, via a dedicated line. The first display device D3 may display the camera image for display generated by the control part D3a. At this time, the first display device D3 may display all of the camera images for display generated from each of the photographing devices S6 provided to the excavator 100.

The control part D3a is configured to generate an image for display in accordance with an output by the controller 30. In the present embodiment, the control part D3a converts various information output by the controller 30 into image signals. The information output by the controller 30 includes, for example, data indicating the temperature of engine cooling water, data indicating the temperature of hydraulic oil, data indicating the remaining amount of fuel, data indicating the remaining amount of urea water, data indicating the position of a working portion of the bucket 6, data indicating the orientation of a slope of the working target, data indicating the orientation of the excavator 100, data indicating the operation direction for causing the excavator 100 to directly face a slope, and the like.

Similar to the first display device D3, the second display device D3S includes a control part D3Sa configured to generate an image. In the present embodiment, the second display device D3S is not directly connected to the photographing device S6. Therefore, the control part D3Sa does not generate a camera image. However, when the second display device D3S is directly connected to the photographing device S6, the control part D3Sa may generate a camera image. The second display device D3S may display a camera image for display generated by the photographing device S6 regardless of whether or not the second display device D3S is directly connected to the photographing device S6. Further, the camera images for display generated from the photographing devices S6 may be separately displayed on the first display device D3 and the second display device D3S.

The control part D3Sa generates an image for display in accordance with an output by the controller 30. In the present embodiment, the control part D3Sa converts various information output by the controller 30 into image signals.

The control part D3a may be achieved not as a function included in the first display device D3 but as a function included in the controller 30. The same applies to the control part D3Sa. In this case, the photographing device S6 is connected to the controller 30 rather than the first display device D3.

The first display device D3 and the second display device D3S are driven by receiving power supplied from a storage battery 70. The storage battery 70 is charged with power generated by an alternator 11a (power generator) of the engine 11. The power of the storage battery 70 is supplied not only to the controller 30, the first display device D3, and the second display device D3S, but also to electric components 72 of the excavator 100, and the like. A starter 11b of the engine 11 is driven by power from the storage battery 70, thereby starting the engine 11.

The engine 11 is controlled by the engine controller unit D7. Various types of data indicating the state of the engine 11 are constantly transmitted from the engine controller unit D7 to the controller 30. The various types of data indicating the state of the engine 11 are an example of driving information of the excavator 100, and include, for example, data indicating the temperature of cooling water detected by a water temperature sensor 11c serving as a driving information obtainment part. The controller 30 stores this data in a temporary storage (memory) 30a, and can transmit the data to the first display device D3 if necessary.

Various types of data are supplied to the controller 30 as driving information of the excavator 100 in the following manner, and are stored in the temporary storage 30a of the controller 30.

For example, data indicating a swash plate tilt angle is supplied to the controller 30 from a regulator 13 of the main pump 14, which is a variable displacement hydraulic pump. Data indicating the discharge pressure of the main pump 14 is supplied to the controller 30 from a discharge pressure sensor 14b. The above data is stored in the temporary storage 30a. Also, an oil temperature sensor 14c is provided in a conduit between a tank, which stores the hydraulic oil to be sucked in by the main pump 14, and the main pump 14, and data indicating the temperature of the hydraulic oil flowing through the conduit is supplied to the controller 30 from the oil temperature sensor 14c. The regulator 13, the discharge pressure sensor 14b, and the oil temperature sensor 14c are examples of the driving information obtainment part.

Data indicating the amount of fuel stored is supplied to the controller 30 from a fuel storage amount detecting part 55a in a fuel storage part 55. In the present embodiment, data indicating the remaining amount of fuel is supplied to the controller 30 from a remaining fuel amount sensor, serving as the fuel storage amount detecting part 55a, in a fuel tank serving as the fuel storage part 55.

Specifically, the remaining fuel amount sensor includes: a float configured to follow a liquid surface; and a variable resistor (potentiometer) configured to convert the amount of vertical movement of the float into a resistance value. With this configuration, the remaining fuel amount sensor can continuously display the state of the remaining amount of fuel on the first display device D3. The detection method by the fuel storage amount detecting part may be appropriately selected in accordance with a usage environment and the like, and it is possible to employ a detection method by which the state of the remaining amount of fuel can be displayed stepwise. These configurations also apply to a urea water tank.

An operation device 26 is provided near the operating seat of the cab 10, and is used for an operator to drive various driven components. Specifically, the operation device 26 is used for an operator to drive hydraulic actuators, such as the right and left hydraulic motors for traveling, the boom cylinder 7, the arm cylinder 8, the bucket cylinder 9, the hydraulic motor for slewing, and the like. As a result, the operator can achieve driving of the driven components to be driven by the hydraulic actuators. The operation device 26 includes a pedal and a lever that are configured to drive the driven components.

An operation sensor 29 is configured to detect an operation content of the operator using the operation device 26. In the present embodiment, the operation sensor 29 detects the direction and the amount of the operation on the operation device 26 corresponding to each of the hydraulic actuators, and outputs an electric signal corresponding to a detected value (hereinafter this electric signal is also referred to as an operation signal) to the controller 30. In the present embodiment, the controller 30 controls an opening area of a proportional valve 31 in accordance with the output of the operation sensor 29. The controller 30 feeds the hydraulic oil discharged by the pilot pump 15 to pilot ports of corresponding control valves in the control valve unit 17. The pressure (pilot pressure) of the hydraulic oil fed to each of the pilot ports is, in principle, a pressure in accordance with the direction and the amount of the operation on the operation device 26 corresponding to each of the hydraulic actuators. In this manner, the operation device 26 is configured to feed the hydraulic oil discharged by the pilot pump 15 to the pilot ports of the corresponding control valves in the control valve unit 17. This can drive the hydraulic actuators.

Further, direction switch valves configured to drive the respective hydraulic actuators and built in the control valve unit 17 may be of an electromagnetic solenoid type. In this case, the operation signals output from the operation device 26 may be directly input to the control valve unit 17 (i.e., the direction switch valves of an electromagnetic solenoid type).

The operation device 26 may be of a hydraulic pilot type. Specifically, the operation device 26 utilizes the hydraulic oil supplied from the pilot pump 15 through the pilot line, and outputs the pilot pressure in accordance with operation contents to the pilot line on the secondary side. The pilot line on the secondary side is connected to the control valve unit 17. Thus, the pilot pressure in accordance with the operation contents of the various driven components (hydraulic actuators) of the operation device 26 can be input to the control valve unit 17. Therefore, the control valve unit 17 can drive the respective hydraulic actuators in accordance with the operation contents performed by the operator or the like on the operation device 26. In this case, the operation sensor 29 configured to obtain information about the operation state of the operation device 26 is provided, and the output of the operation sensor 29 is taken into the controller 30. Thus, the controller 30 can identify the operation state of the operation device 26. The operation sensor 29 is, for example, a pressure sensor configured to obtain information about the pilot pressure (operation pressure) of the pilot line on the secondary side of the operation device 26.

Also, some or all of the hydraulic actuators may be replaced with electric actuators. In this case, for example, the controller 30 may output an operation command in accordance with operation contents of the operation device 26 or remote operation contents defined by remote operation signals, to an electric actuator, a driver configured to drive an electric actuator, or the like. Further, the electric actuator may be configured to be operable by the operation device 26 when an operation signal is input from the operation device 26 to the electric actuator, the driver, or the like.

Also, the operation device 26 may be omitted when the excavator 100 is driven mainly by remote operation or mainly by a fully automatic operation function.

The proportional valve 31 functions as a control valve for machine control, and is provided for each of the driven components (hydraulic actuators) to be driven by the operation device 26 and for each of the moving directions (e.g., the raising and lowering directions of the boom 4) of the driven component (hydraulic actuator). For example, two proportional valves 31 are provided for each of the double-acting hydraulic actuators configured to drive the lower traveling body 1, the upper slewing body 3, the boom 4, the arm 5, the bucket 6, and the like. The proportional valve 31 may be provided, for example, in a pilot line between the pilot pump 15 and the control valve unit 17, and may be configured so as to change the flow path area (i.e., the cross-sectional area through which hydraulic oil can flow). Thus, the proportional valve 31 can output a predetermined pilot pressure to the pilot line on the secondary side by utilizing the hydraulic oil of the pilot pump 15 supplied through the pilot line on the primary side. Therefore, the proportional valve 31 can apply a predetermined pilot pressure to the control valve unit 17 in accordance with an operation command from the controller 30. Thus, for example, the controller 30 can cause the proportional valve 31 to directly supply, to the control valve unit 17, the pilot pressure in accordance with the operation contents (operation signals) of the operation device 26, and can achieve the movement of the excavator 100 in accordance with the operation performed by the operator.

Also, the controller 30 may control the proportional valve 31 to achieve an automatic operation function of the excavator 100. Specifically, the controller 30 outputs, to the proportional valve 31, an operation command corresponding to the automatic operation function from the proportional valve 31. Thus, the controller 30 can achieve the driving of the excavator 100 in accordance with the automatic operation function.

Also, the controller 30 controls the proportional valve 31 to achieve a remote operation of the excavator 100. Specifically, the controller 30 outputs, to the proportional valve 31, an operation command corresponding to operation contents designated by operation signals received by the communication device T1 from a remote operation room RC. Thus, the controller 30 causes the proportional valve 31 to supply the pilot pressure in accordance with remote operation contents to the control valve unit 17, thereby enabling achievement of the driving of the excavator 100 in accordance with the remote operation performed by the operator.

When the operation device 26 is of a hydraulic pilot type, a shuttle valve may be provided in the pilot lines between: the operation device 26 and the proportional valve 31; and the control valve unit 17. The shuttle valve includes two inlet ports and one outlet port, and outputs, to the outlet port, the hydraulic oil having the higher pilot pressure among the pilot pressures input to the two inlet ports. Similar to the proportional valve 31, the shuttle valve is provided for each of the driven components (hydraulic actuators) to be driven by the operation device 26 and for each of the moving directions of the driven component (hydraulic actuator). For example, two shuttle valves are provided for each of the double-acting hydraulic actuators configured to drive the lower traveling body 1, the upper slewing body 3, the boom 4, the arm 5, the bucket 6, and the like. One of the two inlet ports of the shuttle valve is connected to the pilot line on the secondary side of the operation device 26 (specifically, the above-described lever or pedal included in the operation device 26) and the other is connected to the pilot line on the secondary side of the proportional valve 31. The outlet port of the shuttle valve is connected through the pilot line to the pilot port of a corresponding direction switch valve of the control valve unit 17. The corresponding direction switch valve is a direction switch valve configured to drive a hydraulic actuator that is to be operated by the above-described lever or pedal connected to the inlet port of one of the shuttle valves. Therefore, these shuttle valves can each apply, to the pilot port of the corresponding direction switch valve, the higher pilot pressure selected from among the pilot pressure of the pilot line on the secondary side of the operation device 26, and the pilot pressure of the pilot line on the secondary side of the proportional valve 31. That is, by causing the proportional valve 31 to output the pilot pressure that is higher than the pilot pressure on the secondary side of the operation device 26, the controller 30 can control the corresponding direction switch valve independently of the operation performed by the operator on the operation device 26. In other words, independently of the operation performed by the operator on the operation device 26, the controller 30 can control the driving of the driven components (the lower traveling body 1, the upper slewing body 3, the boom 4, the arm 5, and the bucket 6), thereby enabling achievement of an automatic operation function and a remote operation function.

When the operation device 26 is of a hydraulic pilot type, a pressure reducing valve may be provided, in addition to the shuttle valve, in the pilot line between the operation device 26 and the shuttle valve. For example, the pressure reducing valve is configured to be driven in accordance with control signals input from the controller 30, and change the flow path area. Thus, even if the operation device 26 is being operated by the operator, the controller 30 can forcibly reduce the pilot pressure output from the operation device 26. Therefore, even if the operation device 26 is being operated, the controller 30 can forcibly suppress or stop the driving of the hydraulic actuator in accordance with the operation performed on the operation device 26. Also, even if the operation device 26 is being operated, the controller 30 can reduce the pilot pressure output from the operation device 26 by use of the pressure reducing valve, and reduce the pilot pressure to be lower than the pilot pressure output from the proportional valve 31. Therefore, by controlling the proportional valve 31 and the pressure reducing valve, for example, the controller 30 can reliably apply a desired pilot pressure to the pilot port of the direction switch valve in the control valve unit 17 independently of the operation contents of the operation device 26. Thus, for example, by controlling the pressure reducing valve in addition to the proportional valve 31, the controller 30 can more appropriately achieve the automatic operation function and the remote operation function of the excavator 100.

The communication system of the excavator 100 according to the present embodiment includes the communication device T1.

The communication device T1 is connected to an external communication line, and communicates with a device provided separately from the excavator 100. The device provided separately from the excavator 100 may include not only a device outside the excavator 100, but also a portable terminal device (portable terminal) to be carried into the cab 10 by the user of the excavator 100. The communication device T1 may include, for example, a mobile communication module in compliant to a standard, such as 4G (4^{th} Generation), 5G (5^{th} Generation), or the like. The communication device T1 may include, for example, a satellite communication module. Also, the communication device T1 may include, for example, a Wi-Fi communication module, a BLUETOOTH (registered trademark) communication module, or the like. When there are a plurality of connectable communication lines, the communication device T1 may include a plurality of communication devices T1 in accordance with the types of the communication lines.

For example, the communication device T1 communicates with an external device, such as, for example, a remote operation room at a work site through a local communication line constructed in the work site. The local communication line is, for example, a mobile communication line using local 5G or a local network using Wi-Fi, which is constructed in the work site.

The communication device T1 is configured to transmit and receive information to and from the communication device disposed in the remote operation room through a communication line for a wide area including the work site, i.e., a wide-area network.

In the present embodiment, description will be given of a case in which the movement of the attachment AT, the slewing of the upper slewing body 3, and the traveling are performed by using the engine 11 as a driving source and driving the hydraulic pump with a driving force generated by the engine 11. However, the present embodiment does not limit the driving source to the engine 11, and a motor may be used as the driving source. That is, control described in the present embodiment may be applied to what is referred to as an electric excavator in which a motor serving as a driving source is driven by power supplied from a battery, or may be applied to an excavator including a plurality of driving sources.

### Outline of Process Performed by Controller and Display Device

The controller 30 according to the present embodiment is configured to detect an object from the photographed image data obtained by the photographing device S6. Then, the first display device D3 displays display information indicating the detected object so as to be identifiable, together with the photographed image data. In the present embodiment, a frame is an example of the display information.

For example, the first display device D3 encloses a human included in the photographed image data by a frame (an example of the display information) or the like, and thus the operator can recognize that the human exists around the excavator 100.

However, false detection may occur in the detection of an object by the controller 30. For example, the controller 30 may falsely detect, as a human, a non-human object existing around the excavator 100. In such case, the first display device D3 would display the non-human object as a human, by being enclosed by a frame or the like. When the operator refers to the non-human object enclosed by the frame, the operator may feel inconvenienced.

Further, the controller 30 might perform safety control in accordance with the contents of the false detection. The safety control performed by the excavator 100 includes, for example, one or more of restriction of the driving of the excavator 100, stopping of the excavator 100, output of an alarm by means of sound, light, or vibration, and highlighting of the detected object in the first display device D3.

When the controller 30 restricts, as the safety control, the driving of the excavator 100, e.g., the slewing of the upper slewing body 3, or restricts the opening or closing of the attachment AT, the current operation of the excavator 100 may be suppressed. Further, when the controller 30 stops the excavator 100 as the safety control, the current operation of the excavator 100 is stopped. When the controller 30 restricts the driving of the excavator 100 or stops the excavator 100 due to false detection of a non-human object as a human, the operation is suppressed or stopped, and the work efficiency decreases.

Also, when the controller 30 outputs an alarm as the safety control, the operator needs to stop the operation of the excavator 100, and confirm the surroundings. This confirmation is meaningful when there is actually a human in the surroundings. However, in the case of false detection, the operator needs to confirm the surroundings even though there is no human in the surroundings. In this manner, regardless of whether or not false detection occurs, the operator needs to temporarily stop the current operation of the excavator 100, and confirm the surroundings in accordance with the output of the alarm. When the controller 30 outputs an alarm due to false detection of a non-human object as a human, the operator needs to confirm the surroundings, and the work efficiency decreases.

Further, when the controller 30 highlights the detected object on the first display device D3 as the safety control, the operator needs to carefully monitor the first display device D3 and determine what the highlighted object is. When false detection occurs, the operator needs to confirm the highlighted object even though the highlighted object is not a human or the like. When the controller 30 highlights a non-human object, the operator needs to recognize what object the highlighted object is, and the operator feels inconvenienced. The operation is suspended in order to recognize what the object is, and the work efficiency decreases.

Therefore, the controller 30 according to the present embodiment has the function of correcting the detection result when false detection of an object occurs.

### Block Configuration of Excavator Controller

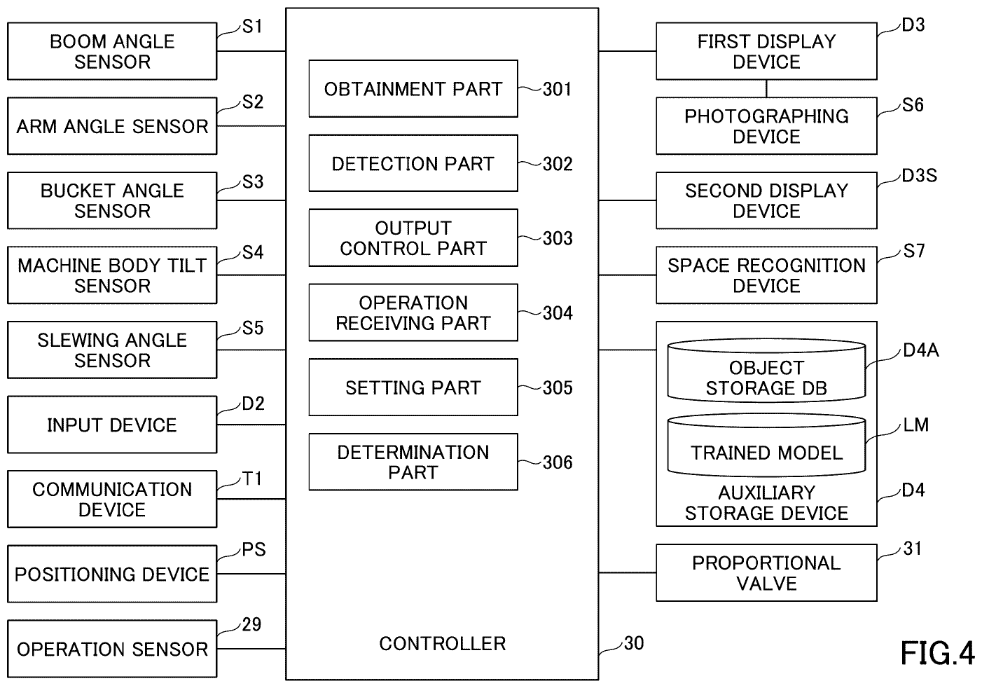

FIG. 4 is a functional block diagram illustrating a configuration example of the controller 30 of the excavator 100 according to the present embodiment. In the example illustrated in FIG. 4, a block configuration of the controller 30 of the excavator 100 is illustrated.

The controller 30 receives information output by the boom angle sensor S1, the arm angle sensor S2, the bucket angle sensor S3, the machine body tilt sensor S4, the slewing angle sensor S5, the photographing device S6, the input device D2, the communication device T1, the positioning device PS, and the like. In accordance with the received information and the information stored in an auxiliary storage device D4, various calculations are performed, and calculation results are output to the first display device D3, the second display device D3S, the proportional valve 31, and the like.

Although the present embodiment is described using an example in which the controller 30 controls the excavator 100, some of the functions of the controller 30 may be achieved by another controller (control device). That is, the functions of the controller 30 may be achieved in a distributed manner by a plurality of controllers mounted on the excavator 100.

The controller (an example of the control device) 30 is a calculation device configured to perform various calculations. In the present embodiment, the controller 30 is configured by a microcomputer including a central processing unit (CPU) and a memory. Various functions of the controller 30 are achieved by the CPU executing programs stored in the memory.

In response to receiving an operation performed by an operator in the cab 10, the excavator 100 drives actuators (e.g., hydraulic actuators) to drive moving components (hereinafter referred to as “driven components”), such as the lower traveling body 1, the upper slewing body 3, the boom 4, the arm 5, the bucket 6, and the like.

In addition to or instead of being configured to be operable by an operator of the cab 10, the excavator 100 may be configured to be remotely operable (remote operation) from the exterior of the excavator 100. When the excavator 100 is remotely operated, the cab 10 need not include an operator.

The auxiliary storage device D4 stores a trained model LM and an object storage database D4A.

When the photographed image data obtained by the photographing device S6 is input from an input layer, a trained model LM outputs, from an output layer, a coordinate region, in which a human included in the photographed image data exists, and a frame size for enclosing the human.

Further, the trained model LM according to the present embodiment may detect a non-human object. For example, the trained model LM may detect a work machine. Specifically, when the photographed image data obtained by the photographing device S6 is input from an input layer, the trained model LM outputs, from an output layer, a coordinate region, in which a work machine included in the photographed image data exists, and a frame size for enclosing the work machine.

The present embodiment does not limit the trained model LM with regard to the manner to output a coordinate region, in which a human or a work machine exists, and a frame size for enclosing the work machine or the human, as long as the trained model LM outputs information that can identify a region in which a human or a work machine exists.

As machine learning used for generating the trained model LM, for example, a neural network may be applicable. Specifically, machine learning using a deep neural network (DNN), i.e., deep learning, may be applicable. As the deep learning, for example, a convolutional neural network, a recurrent neural network (RNN), or a long short term memory (LSTM) may be applicable.

The trained model LM is generated by performing machine learning in accordance with a training dataset generated in advance in an information processing device (not shown).

Specifically, the trained model LM is generated through machine learning in accordance with: the training dataset that contains photographed image data including a human or a work machine; and a coordinate region, in which the human or the work machine included in the photographed image data exists, and a frame size for enclosing the work machine or the human.

The trained model LM may be updated by causing the existing trained model LM to experience additional training using a new training dataset.

The object storage database D4A is a database configured to store an object whose detection is to be suppressed, among objects detected by the trained model LM as a human or a work machine.

The object storage database D4A according to the present embodiment stores image data including the object whose detection is to be suppressed. The present embodiment does not limit the object storage database D4A with regard to the manner of storing image data including the object whose detection is to be suppressed. The object storage database D4A may store information about features extracted from the image data including the object.

The number of pieces of image data that can be stored in the object storage database D4A may be as desired and, for example, may be tens of pieces, hundreds of pieces, or more. The image data stored in the object storage database D4A may be initialized at a desired timing. For example, the image data stored in the object storage database D4A may be initialized every time the work site is changed, or may be initialized every day.

The controller 30 includes an obtainment part 301, a detection part 302, an output control part 303, an operation receiving part 304, a setting part 305, and a determination part 306.

The obtainment part 301 is configured to obtain various information from various sensors. For example, the obtainment part 301 obtains photographed image data obtained by the photographing device S6 (the left camera S6L, the right camera S6R, and the rear camera S6B).

The obtainment part 301 obtains detection information detected by the boom angle sensor S1, the arm angle sensor S2, the bucket angle sensor S3, the machine body tilt sensor S4, and the slewing angle sensor S5. The obtainment part 301 obtains the position and the orientation of the excavator 100 from the positioning device PS.

The detection part 302 is configured to perform a detection process of detecting a human and a work machine existing around the excavator 100 from the photographed image data obtained by the obtainment part 301. By inputting the photographed image data into the trained model LM, the detection part 302 according to the present embodiment receives, from the trained model LM, a coordinate region, in which a work machine or a human exists, and a frame size for enclosing the work machine or the human. In the present embodiment, a method of detecting one or more humans or one or more work machines using the trained model LM will be described. However, the present embodiment does not intend any limitation to the method of detecting one or more humans or one or more work machines, and various methods including well-known methods may be used. For example, a determination may be performed as to whether or not a feature extracted from the photographed image data is close to a predetermined feature indicating a human by a predetermined value or more. Further, the object to be detected is not limited to a human or a work machine, and may be any other object.

The output control part 303 is configured to output the slewing angle, the coordinate region and frame size, in which one or more humans or one or more work machines exist, and the detection results of various sensors, to the control part D3a of the first display device D3. As a result, the first display device D3 displays a screen indicating the surroundings of the excavator 100.

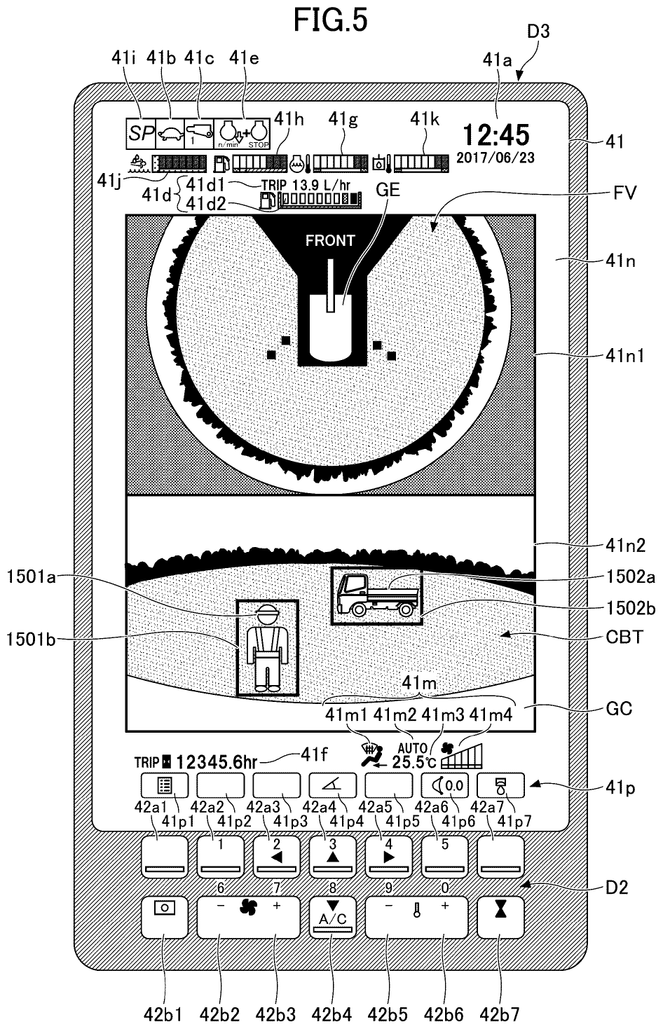

Next, an example of a display screen to be displayed on the first display device D3 will be described with reference to FIG. 5. FIG. 5 is a view illustrating an example of the input device D2 and a display screen 41 displayed by the first display device D3 according to the present embodiment.

The control part D3a according to the present embodiment generates a display screen in accordance with the image data input from the photographing device S6, and various information received from the controller 30. The information received from the controller 30 includes the slewing angle, the coordinate region, in which a work machine or a human exists, the frame size for enclosing the work machine or the human, and the detection results obtained by the various sensors.

As illustrated in FIG. 5, the display screen 41 includes a date-and-time display section 41a, a traveling mode display section 41b, an attachment display section 41c, a fuel consumption display section 41d, an engine control state display section 41e, an engine operating time display section 41f, a cooling water temperature display section 41g, a remaining fuel amount display section 41h, a rotation speed mode display section 41i, a remaining urea water amount display section 41j, a hydraulic oil temperature display section 41k, an air conditioner operating state display section 41m, an image display section 41n, and a menu display section 41p.

The traveling mode display section 41b, the attachment display section 41c, the engine control state display section 41e, the rotation speed mode display section 41i, and the air conditioner operating state display section 41m are sections for displaying setting state information, which is information about the setting state of the excavator 100. The fuel consumption display section 41d, the engine operating time display section 41f, the cooling water temperature display section 41g, the remaining fuel amount display section 41h, the remaining urea water amount display section 41j, and the hydraulic oil temperature display section 41k are sections for displaying operating state information, which is information about the operating state of the excavator 100.

Specifically, the date-and-time display section 41a is a section for displaying the current date and time. The traveling mode display section 41b is a section for displaying the current traveling mode. The attachment display section 41c is a section for displaying an image including an attachment that is currently attached. The fuel consumption display section 41d is a section for displaying fuel consumption information calculated by the controller 30. The fuel consumption display section 41d includes an average fuel consumption display section 41d1 for displaying lifetime average fuel consumption or sectional average fuel consumption, and an instantaneous fuel consumption display section 41d2 for displaying instantaneous fuel consumption.

The engine control state display section 41e is a section for displaying the control state of the engine 11. The engine operating time display section 41f is a section for displaying a cumulative operating time of the engine 11. The cooling water temperature display section 41g is a section for displaying the current temperature of the engine cooling water. The remaining fuel amount display section 41h is a section for displaying the remaining amount of fuel stored in a fuel tank. The rotation speed mode display section 41i is a section for displaying, as an image, the current rotation speed mode set by an engine rotation speed adjustment dial 75. The remaining urea water amount display section 41j is a section for displaying, as an image, the remaining amount of urea water stored in a urea water tank. The hydraulic oil temperature display section 41k is a section for displaying the temperature of the hydraulic oil in a hydraulic oil tank.

The air conditioner operating state display section 41m includes an air outlet display section 41m1 for displaying the current position of an air outlet, an operation mode display section 41m2 for displaying the current operation mode, a temperature display section 41m3 for displaying the current set temperature, and an air volume display section 41m4 for displaying the current set air volume.

The image display section 41n is a section for displaying an image photographed by the photographing device S6. In the example of FIG. 5, the image display section 41n displays a bird's-eye view image FV and a rearward image CBT. The bird's-eye view image FV is an imaginary viewpoint image generated by the control part D3a, and is generated in accordance with images obtained by the rear camera S6B, the left camera S6L, and the right camera S6R. An excavator figure GE corresponding to the excavator 100 is disposed at the center of the bird's-eye view image FV. By this, the operator can intuitively understand the positional relationship between the excavator 100 and objects existing around the excavator 100. The rearward image CBT is an image showing a space rearward of the excavator 100, and includes a counterweight image GC. The rearward image CBT is a real viewpoint image generated by the control part D3a, and is generated in accordance with an image obtained by the rear camera S6B.

The image display section 41n includes a first image display section 41n1 located in an upper portion, and a second image display section 41n2 located in a lower portion. According to the example of FIG. 5, the bird's-eye view image FV is disposed in the first image display section 41n1, and the rearward image CBT is disposed in the second image display section 41n2. However, the image display section 41n may be such that the bird's-eye view image FV is disposed in the second image display section 41n2, and the rearward image CBT is disposed in the first image display section 41n1. According to the example of FIG. 5, the bird's-eye view image FV and the rearward image CBT are disposed in contact with each other in the vertical direction, but may be disposed with a gap therebetween. According to the example of FIG. 5, the image display section 41n is a vertically long section, but the image display section 41n may be a horizontally long section. In a case where the image display section 41n is a horizontally long section, the image display section 41n may include the bird's-eye view image FV disposed leftward as the first image display section 41n1, and the rearward image CBT disposed rightward as the second image display section 41n2. In this case, these images may be disposed rightward and leftward with a gap therebetween, or the bird's-eye view image FV and the rearward image CBT may be transposed. Further, in a case where the front camera is provided at the upper slewing body 3, a frontward image showing a space frontward of the excavator 100 obtained by the front camera may be disposed in the image display section included in the image display section 41n.

When the controller 30 detects a work machine or a human from the rearward image (an example of the photographed image data) CBT disposed in the second image display section 41n2, a frame (an example of the display information) is displayed in the second image display section 41n2 so as to enclose the work machine or the human. Specifically, a frame 1501b indicating a detected human 1501a is displayed in the second image display section 41n2. Further, a frame 1502b indicating a detected dump truck 1502a is displayed in the second image display section 41n2. The frame is an example of the display information disposed in accordance with the coordinate region and the frame size received from the controller 30. The present embodiment is described based on an example using a frame as the display information indicating a work machine or a human. However, the present embodiment does not limit the display information indicating a work machine or a human to being a frame. For example, the display information indicating a work machine or a human may be an icon (an exclamation mark, a face icon, an icon indicating danger, or the like).

Further, the color of a frame may be changed in accordance with the type of object enclosed by the frame. For example, the color of a frame enclosing a human may differ from the color of a frame enclosing a work machine.

The present embodiment is described based on an example in which the work machine enclosed by the frame is a dump truck. However, the present embodiment does not limit the work machine enclosed by the frame to the dump truck. For example, the work machine enclosed by the frame may be an excavator, a crawler crane, a jib crane, an asphalt finisher, a load roller, or the like.

The menu display section 41p includes tabs 41p1 to 41p7. In the example of FIG. 5, the tabs 41p1 to 41p7 are disposed rightward and leftward at intervals in the lowest part of the display screen 41. Icons displaying various information are displayed on the tabs 41p1 to 41p7.

A menu details icon for displaying menu details is displayed on the tab 41p1. When the tab 41p1 is selected by the operator, the icons displayed on the tabs 41p2 to 41p7 are switched to icons associated with the menu details.

The icon displaying information about a digital level is displayed on the tab 41p4. When the tab 41p4 is selected by the operator, the rearward image CBT is switched to a screen indicating information about the digital level. However, the screen indicating information about the digital level may be displayed by overlapping with the rearward image CBT or reducing the size of the rearward image CBT. Also, the bird's-eye view image FV may be switched to a screen indicating information about the digital level. Further, the screen indicating information about the digital level may be displayed by overlapping with the bird's-eye view image FV or reducing the size of the bird's-eye view image FV.

An icon displaying information about information-based construction is displayed on the tab 41p6. When the tab 41p6 is selected by the operator, the rearward image CBT is switched to a screen indicating information about the information-based construction. However, the screen indicating information about the information-based construction may be displayed by overlapping with the rearward image CBT or reducing the size of the rearward image CBT. Also, the bird's-eye view image FV may be switched to a screen indicating information about the information-based construction. Further, the screen indicating information about the information-based construction may be displayed by overlapping with the bird's-eye view image FV or reducing the size of the bird's-eye view image FV.

An icon displaying information about a crane mode is displayed on the tab 41p7. When the tab 41p7 is selected by the operator, the rearward image CBT is switched to a screen indicating information about the crane mode. However, the screen indicating information about the crane mode may be displayed by overlapping with the rearward image CBT or reducing the size of the rearward image CBT. Also, the bird's-eye view image FV may be switched to a screen indicating information about the crane mode. Further, the screen indicating information about the crane mode may be displayed by overlapping with the bird's-eye view image FV or reducing the size of the bird's-eye view image FV.

No icons are displayed on the tabs 41p2, 41p3, and 41p5. Therefore, even if the tabs 41p2, 41p3, and 41p5 are operated by the operator, no change occurs in the image displayed on the display screen 41.

The icons displayed on the tabs 41p1 to 41p7 are not limited to the above-described examples, and an icon displaying other information may be displayed.

Next, the input device D2 will be described. As illustrated in FIG. 5, the input device D2 includes one or more button switches by which the operator performs selection of the tabs 41p1 to 41p7, an input for setting, and the like. In the example of FIG. 5, the input device D2 includes seven switches 42a1 to 42a7 disposed in the upper stage and seven switches 42b1 to 42b7 disposed in the lower stage. The switches 42b1 to 42b7 are disposed below the switches 42a1 to 42a7. However, the number, form, and arrangement of the switches of the input device D2 are not limited to the above-described example. The functions of a plurality of button switches may be integrated into one, for example, with a jog wheel, a jog switch, or the like. Alternatively, the input device D2 may be provided separately from the first display device D3.

The switches 42a1 to 42a7 are disposed below the tabs 41p1 to 41p7 so as to correspond to the tabs 41p1 to 41p7. The switches 42a1 to 42a7 function as switches configured to select the tabs 41p1 to 41p7. Because the switches 42a1 to 42a7 are disposed below the tabs 41p1 to 41p7 so as to correspond to the tabs 41p1 to 41p7, the operator can intuitively select the tabs 41p1 to 41p7.

The switch 42b1 is a switch configured to switch the photographed image displayed in the image display section 41n. Every time the switch 42b1 is operated, the photographed image displayed in the first image display section 41n1 of the image display section 41n is switched, for example, between the rearward image, the leftward image, the rightward image, and the bird's-eye view image. Alternatively, every time the switch 42b1 is operated, the photographed image displayed in the second image display section 41n2 of the image display section 41n may be switched, for example, between the rearward image, the leftward image, the rightward image, and the bird's-eye view image. Alternatively, every time the switch 42b1 is operated, the photographed image displayed in the first image display section 41n1 of the image display section 41n may be transposed with the photographed image displayed in the second image display section 41n2 of the image display section 41n. In this manner, the switch 42b serving as the input device D2 may switch the screen displayed on the first image display section 41n1 or the second image display section 41n2, or may perform switching between the screen displayed on the first image display section 41n1 and the screen displayed on the second image display section 41n2. Alternatively, a switch configured to switch the screen displayed on the second image display section 41n2 may be provided separately.

The switches 42b2 and 42b3 are switches configured to adjust the air volume of the air conditioner. In the example of FIG. 5, the air volume of the air conditioner decreases when the switch 42b2 is operated, and the air volume of the air conditioner increases when the switch 42b3 is operated.

The switch 42b4 is a switch configured to turn on or off cooling and heating functions. In the example of FIG. 5, the cooling and heating functions are turned on or off every time the switch 42b4 is operated.

The switches 42b5 and 42b6 are switches configured to adjust a set temperature of the air conditioner. In the example of FIG. 5, the set temperature decreases when the switch 42b5 is operated, and the set temperature increases when the switch 42b6 is operated.

The switch 42b7 can switch the display of the engine operating time display section 41f.

The switches 42a2 to 42a6 and 42b2 to 42b6 are each configured to receive an input of the number displayed on or near the switch. When a cursor is displayed on the menu screen, the switches 42a3, 42a4, 42a5, and 42b4 are configured to move the cursor leftward, upward, rightward, and downward, respectively.

The functions provided to the switches 42a1 to 42a7 and 42b1 to 42b7 are merely examples, and may be configured to perform other functions.

Further, the input device D2 according to the present embodiment includes a touch panel configured to receive an operation to indicate any positional coordinates in the display screen 41 displayed on the first display device D3. Thus, the input device D2 enables direct operation of the tabs 41p1 to 41p7. Further, the input device D2 enables direct operation of the bird's-eye view image FV and the rearward image CBT in the image display section 41n. Direct operation on the rearward image CBT will be described below.

As illustrated in FIG. 4, the operation receiving part 304 receives, from the operation sensor 29, information input to the operation device 26. Further, the operation receiving part 304 receives, from the input device D2, information input to the input device D2.

For example, the operation receiving part 304 receives an operation to designate an object enclosed by a frame in the photographed image data displayed in the first image display section 41n1 or the second image display section 41n2, via the touch panel of the input device D2. In the present embodiment, an intuitive operation is achieved by designating an object via the touch panel, and thus an improvement in operability can be achieved. In the present embodiment, a touch panel is used as an example for the operation to designate an object. However, the operation to designate an object is not limited to the operation via a touch panel, and may be any other operation. For example, an object may be selected by pressing a button of the input device D2.

For example, when the controller 30 falsely detects an object, the first display device D3 displays a frame indicating the falsely detected object. In the present embodiment, in order to hide the frame for the falsely detected object, the operation receiving part 304 receives an operation to designate the object enclosed by the frame.

When the setting part 305 receives an operation to designate an object included in the photographed image data, the setting part 305 sets object-including image data (an example of the information indicating the object) so as to suppress detection of the object. Specifically, the setting part 305 registers the image data including the designated object in the object storage database D4A for storage of the objects whose detection is to be suppressed. In other words, the image data registered in the object storage database D4A is regarded as having undergone a setting for suppression of detection. In the present embodiment, an example of registering the image data in the object storage database D4A will be described as an example of a setting for suppression of detection. Any other method may be used as long as a selected method enables suppression of detection.

The determination part 306 is configured to determine whether or not a partial region of the photographed image data indicated by the coordinate region and the frame size that are detected by the detection part 302 is similar to image data registered in the object storage database D4A by a predetermined threshold or more. For example, the predetermined threshold may be 80%. The predetermined threshold is determined individually for each embodiment.

When the determination part 306 determines that the partial region is similar to image data registered in the object storage database D4A by a predetermined threshold or more, the determination part 306 regards the object of interest as a target whose detection is to be suppressed, and suppresses output of a coordinate region and a frame size regarding the object of interest to the first display device D3. Thus, the first display device D3 suppresses display of a frame indicating the object of interest.

Thus, when an object indicated by the image data registered in the object storage database D4A is detected from the photographed image data, the first display device D3 suppresses display of a frame (an example of the display information) indicating the object. In the present embodiment, it is possible to suppress display in which a falsely detected human or the like is enclosed by a frame. Thus, when an operator refers to the display screen, there is no need to confirm that the object enclosed by the frame is not a human, and therefore, it is possible to avoid inconvenience. As such, an improvement in convenience can be achieved.

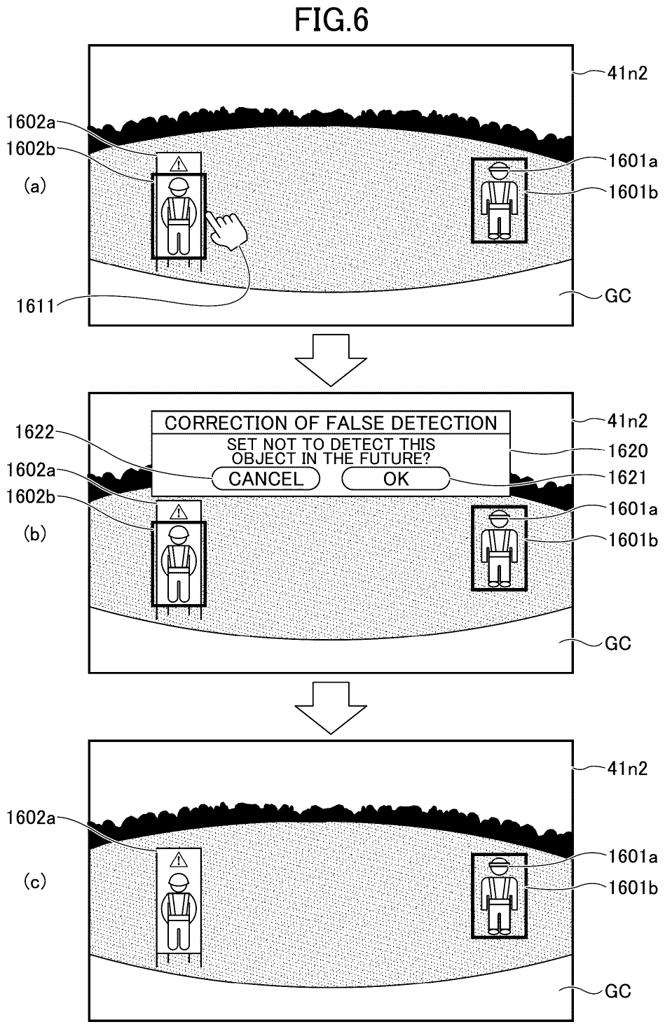

FIG. 6 is a view illustrating a transition in the rearward image CBT disposed in the second image display section 41n2, under control of the controller 30 and the first display device D3.

The rearward image CBT disposed in the second image display section 41n2 illustrated in (a) of FIG. 6 is, for example, a rearward image in which a human drawn on a signboard 1602a is detected together with a human 1601a. Therefore, the first display device D3 displays a frame 1601b enclosing the human 1601a, and a frame 1602b enclosing the human drawn on the signboard 1602a.

The example illustrated in FIG. 6 is an example of false detection, and does not limit a falsely detected human to a human drawn on a signboard or the like. For example, a remote work machine or the like coated with a reflective material may be falsely detected as a human who is wearing workwear made of a fluorescent material, or a road cone or the like located at the work site may be falsely detected as a human.

That is, various objects exist at the work site, and thus the controller 30 may falsely detect the various objects as a human. When these objects are falsely detected as a human, the first display device D3 displays the falsely detected object with a frame (which is for indicating a human). In this case, when the operator refers to the screen displayed on the first display device D3, the operator needs to recognize the false detection, and thus the operator may feel inconvenienced. Further, the controller 30 may perform safety control in accordance with the result of the false detection. In the example illustrated in (a) of FIG. 6, the signboard 1602a is falsely detected as a human, and thus the controller 30 may perform the function of restricting traveling or slewing so as not to contact the signboard 1602a. Further, the controller 30 may output an alarm sound because a human is being approached. In such a situation, the operator may be unable to perform efficient work.

Therefore, the operation receiving part 304 receives pressing of the frame 1602b or the interior of the frame 1602b with a finger 1611 of the operator via the touch panel. This pressing means selection of the object included in the frame 1602b.

Then, as illustrated in (b) of FIG. 6, when the pressing of the frame 1602b or the interior of the frame 1602b is received, the first display device D3 displays a pop-up window 1620. The pop-up window 1620 displays an OK button 1621 and a cancel button 1622, together with the message: “Set not to detect this object in the future?”. When the operation receiving part 304 receives pressing of the cancel button 1622, the first display device D3 closes the pop-up window 1620.

When the operation receiving part 304 receives pressing of the OK button 1621, the setting part 305 registers, in the object storage database D4A, the image data of the object corresponding to the frame 1602b (in other words, the image data indicated by the coordinate region and the frame size). Then, the first display device D3 closes the pop-up window 1620.

When the pressing of the OK button 1621 is received, the image data of the object corresponding to the frame 1602b is registered in the object storage database D4A, and thus the determination part 306 determines that the human drawn on the signboard 1602a is an object whose detection is to be suppressed.

Therefore, as illustrated in (c) of FIG. 6, the first display device D3 suppresses the display of the frame 1602b enclosing the human drawn on the signboard 1602a.

In the present embodiment, by performing the above-described control, it is possible to hide the frame displayed in accordance with the false detection.

As described above, in the present embodiment, the setting part 305 performs a setting for suppression of the detection of the object in accordance with the operation received from the input device D2 for a period during which the excavator 100 is in operation. That is, when false detection of an object existing at the work site occurs for a period during which the excavator 100 is in operation, detection of this object can be suppressed immediately. Therefore, after the setting, the operator does not need to confirm whether or not false detection occurs for a period during which the excavator 100 is in operation, and thus the operator can perform the work comfortably. Further, it is possible to suppress safety control performed by the controller 30 in accordance with the result of the false detection, and thus the work efficiency can be improved. The present embodiment does not intend any limitation on the method for setting suppression of the detection of the object while the excavator 100 is in operation. For example, the setting for suppression of the detection of the object may be performed before the start of operation of the excavator 100.

The period during which the excavator 100 is in operation means at least a period during which the excavator 100 is turned on, and the excavator 100 is operable in accordance with the operation performed by an operator. As a specific example, the period during which the excavator 100 is in operation is a period during which the excavator 100 is excavating, leveling the ground, loading, slewing, or moving. Even if false detection occurs during the operation of the excavator 100, the operator performs an operation to suppress the false detection, thereby suppressing false detection during a subsequent operation. That is, the present embodiment enables suppression of false detection without awaiting completion of the work.

The present embodiment is described with reference to the example in FIG. 6, in which the human drawn on the signboard 1602a is an object whose detection is to be suppressed. However, the object whose detection is to be suppressed may be any object, and any object can be registered in the object storage database D4A as long as it is an object indicated by a frame.

The controller 30 according to the present embodiment determines whether or not a partial region of the photographed image data is similar to image data registered in the object storage database D4A. That is, when the object included in the partial region of the photographed image data is a still object, it is possible to determine this similarity with higher accuracy.

Assuming that the image data of a human is mistakenly registered in the object storage database D4A, it is highly likely that because the human is moving, the determination part 306 determines there to be no similarity when determining similarity between the partial region of the photographed image data including the human and the image data of the human registered in the object storage database D4A. That is, a human is not readily set as an object whose detection is to be suppressed, and this can maintain safety.

In the past, when an approaching object was falsely detected as a human, safety control, such as output of an alarm sound or the like, was performed every time the upper slewing body slewed. This is a situation inconvenient to an operator. Meanwhile, in the present embodiment, every time the upper slewing body 3 slews, an image of the object is registered several times in the object storage database D4A, thereby suppressing false detection of the object that occurs every time the upper slewing body 3 slews. Therefore, the safety control operation can be suppressed, and thus the work efficiency can be improved.

The first display device D3 according to the present embodiment is not limited to just the method of hiding a frame for an object that is set to have detection of the object suppressed. For example, the first display device D3 may hide a frame for an object that is set to have detection of the object suppressed, and display information indicating suppression of detection near the object. The information indicating suppression of detection is, for example, a small icon with an exclamation mark. The information indicating suppression of detection is a display that does not inhibit the operation performed by an operator. The first display device D3 can cause the operator to recognize suppression of detection of the object by displaying such an icon near the object.

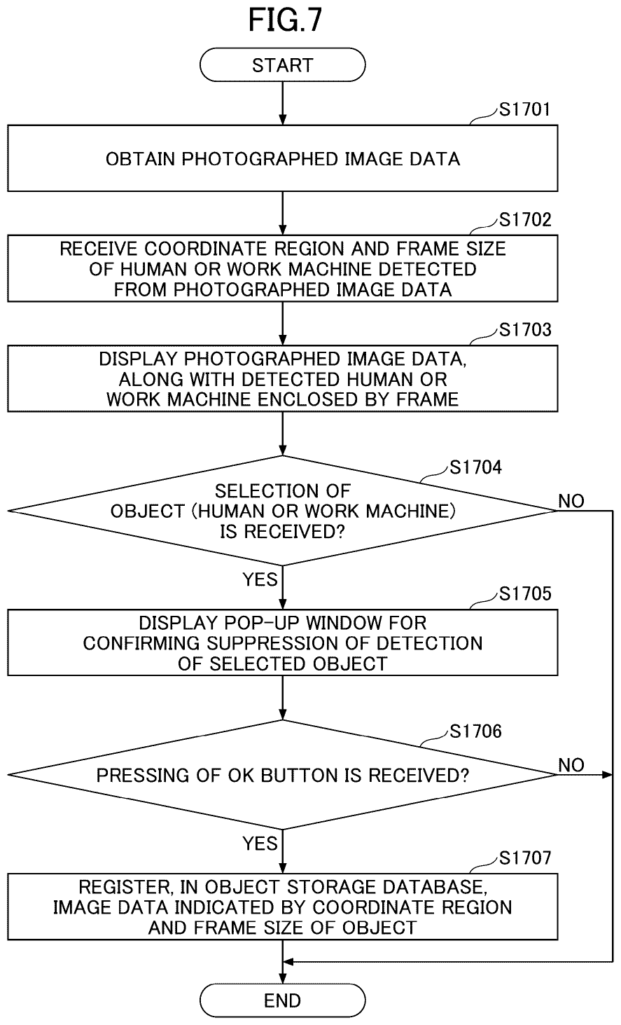

Next, a processing procedure performed by the controller 30 and the first display device D3 according to the present embodiment will be described. FIG. 7 is a flowchart illustrating a setting procedure through which the controller 30 and the first display device D3 according to the present embodiment suppress detection of an object. The flowchart illustrated in FIG. 7 is assumed to be a flowchart in a case in which no image data is registered in the object storage database D4A. The processing procedure illustrated in the flowchart according to the present embodiment is repeated every predetermined cycle.

First, the obtainment part 301 obtains photographed image data obtained by the photographing device S6 (S1701).

By inputting the photographed image data obtained by the obtainment part 301 into the trained model LM, the detection part 302 receives a coordinate region and frame size, in which a human or a work machine exists around the excavator 100 (S1702).

The first display device D3 displays the photographed image data, along with the detected human or work machine enclosed by a frame, in accordance with the coordinate region and the frame size (S1703).

The operation receiving part 304 determines, via the touch panel of the input device D2, whether or not an operation to designate an object enclosed by the frame in the first image display section 41n1 or the second image display section 41n2 is received (S1704). If the operation receiving part 304 determines that the operation to designate the object enclosed by the frame is not received (S1704: NO), the process is ended.

On the other hand, if the operation receiving part 304 determines that the operation to designate the object enclosed by the frame is received (S1704: YES), the first display device D3 displays a pop-up window for confirming suppression of detection of the object (S1705).

The operation receiving part 304 determines whether or not pressing of the OK button 1621 is received (S1706). If the operation receiving part 304 determines that no pressing of the OK button 1621 is received, in other words, pressing of the cancel button is received (S1706: NO), the process is ended.

On the other hand, if the operation receiving part 304 determines that the pressing of the OK button 1621 is received (S1706: YES), the setting part 305 registers, in the object storage database D4A, the image data of the object, indicated by the coordinate region and the frame size, as the setting for suppression of detection of the object (S1707).

By performing the above-described control, the controller 30 and the first display device D3 according to the present embodiment enable a setting for suppression of detection.

In the present embodiment, when image data of an object is registered in the object storage database D4A in accordance with the processing procedure illustrated in FIG. 7, the controller 30 determines whether or not to suppress the detection of the object when displaying the photographed image data on the first display device D3.

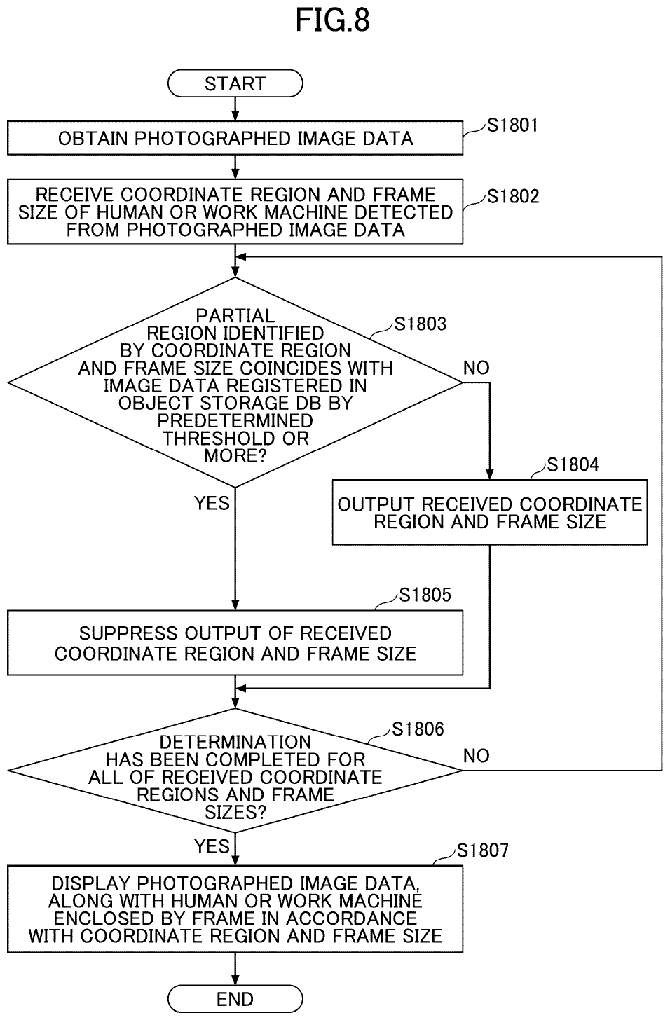

FIG. 8 is a flowchart illustrating a processing procedure in performing a determination using the object storage database D4A when the controller 30 and the first display device D3 according to the present embodiment display the photographed image data.

First, the obtainment part 301 obtains the photographed image data obtained by the photographing device S6 (S1801).

By inputting the photographed image data obtained by the obtainment part 301 into the trained model LM, the detection part 302 receives a coordinate region and frame size, in which a human or a work machine exists around the excavator 100 (S1802).

The determination part 306 determines whether or not a partial region of the photographed image data identified in accordance with the received coordinate region and frame size coincides with image data registered in the object storage database D4A by a predetermined threshold or more (S1803). If the determination part 306 determines that they do not coincide with each other by a predetermined threshold or more (S1803: NO), the received coordinate region and frame size are output to the first display device D3 (S1804).

On the other hand, if the determination part 306 determines that the partial region of the photographed image data identified in accordance with the received coordinate region and frame size coincides with image data registered in the object storage database D4A by a predetermined threshold or more (S1803: YES), the determination part 306 suppresses output of the received coordinate region and frame size to the first display device D3 (S1805).

Then, the determination part 306 determines whether or not the determination has been completed for all of the coordinate regions and the frame sizes received from the trained model LM (S1806). If the determination part 306 determines that the determination is not completed (S1806: NO), the process is performed again from S1803.

If the determination part 306 determines that the determination is completed (S1806: YES), the first display device D3 displays the photographed image data, along with the human or the work machine enclosed by a frame, in accordance with the input coordinate region and frame size (S1807).

In the present embodiment, the above-described processing procedure can suppress display of an object enclosed by a frame, the object having been excluded from objects to be detected.

Further, when the controller 30 has the function of performing safety control in accordance with the detected object, safety control in accordance with an excluded object is suppressed. That is, the controller 30 can suppress the safety control in accordance with a falsely detected object, while causing the safety control to function in accordance with an appropriately detected object. Therefore, according to the present embodiment, it is possible to improve the work efficiency and the safety.

### Modified Example of One Embodiment

The above-described embodiment has been described based on an example in which detection is suppressed using the image data stored in the object storage database D4A. However, the above-described embodiment does not intend any limitation to a method in which the image data stored in the object storage database D4A is used only for suppression of detection.

In a modified example of the one embodiment, the trained model LM may be re-trained using the image data stored in the object storage database D4A as training data. For example, re-training of the trained model LM may be performed at the timing when a predetermined number of pieces of image data are stored in the object storage database D4A.

In order to perform re-training, the controller 30 may generate training data from the image data stored in the object storage database D4A, or a separately provided information processing device may generate training data from the image data.

Further, re-training of the trained model LM in accordance with the generated training data may be performed by the controller 30, or may be performed by a separately provided information processing device. The re-trained model LM is stored in the auxiliary storage device D4. The subsequent process is performed in the same manner as in the above-described embodiment. In the present modified example, an improvement in detection accuracy can be achieved by performing re-training using the image data of the falsely detected object.

### Another Embodiment

The above-described embodiment has been described based on an example in which a human is detected from the photographed image data obtained by the photographing device S6. However, the above-described embodiment is not limited to the method of detecting a human from the photographed image data obtained by the photographing device S6. In the another embodiment, description will be given of a case in which a space recognition device S7 is provided in addition to the photographing device S6.

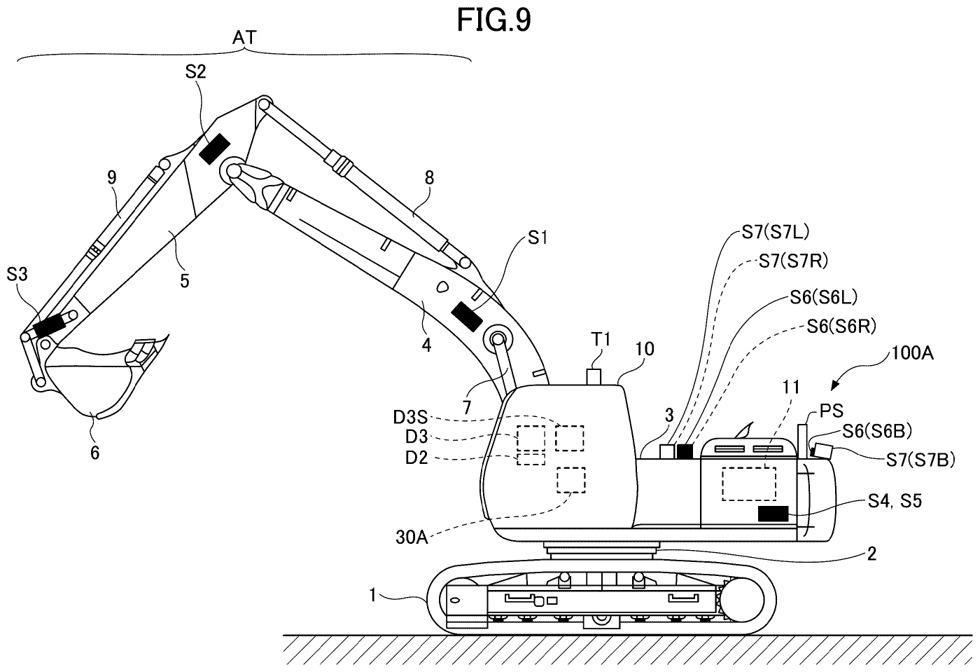

FIG. 9 is a side view of an excavator 100A according to the another embodiment. In the present embodiment, components that are the same as those in the one embodiment are denoted by the same reference symbols, and thus description thereof will be omitted.

The space recognition device S7 is configured to detect the presence or absence of an object existing in a space around the excavator 100A, the distance to an object, and the like. The space recognition device S7 outputs, as measurement information, the result obtained by measuring the space to a controller 30A.

The space recognition device S7 includes a rearward space recognition device S7B configured to detect a space rearward of the excavator 100A, a leftward space recognition device S7L configured to detect a space leftward of the excavator 100A, and a rightward space recognition device S7R configured to detect a space rightward of the excavator 100A.

The space recognition device S7 may use a light detection and ranging (LIDAR) sensor in order to detect objects existing around the excavator 100A. The LIDAR sensor measures, for example, distances between the LIDAR sensor and one million or more points within a surveillance range. The present embodiment does not intend any limitation to a method using the LIDAR sensor as long as the space recognition device S7 is a space recognition device configured to measure distances to objects. For example, the space recognition device may use a stereo camera, or may use a distance measurement device, such as a distance image camera, a millimeter wave radar, or the like. When a millimeter wave radar or the like is used as the space recognition device S7, the space recognition device S7 may emit many signals (e.g., laser beams or the like) toward objects and receive reflected signals, thereby deriving distances and directions of the objects from the reflected signals.

The rearward space recognition device S7B is attached to the rear end of the upper surface of the upper slewing body 3. The leftward space recognition device S7L is attached to the left end of the upper surface of the upper slewing body 3. The rightward space recognition device S7R is attached to the right end of the upper surface of the upper slewing body 3.

The rearward space recognition device S7B, the leftward space recognition device S7L, and the rightward space recognition device S7R are attached to the upper slewing body 3 such that optical axes are oriented obliquely downward and parts of the upper slewing body 3 are included in detection ranges. Therefore, a detection range of each of the rearward space recognition device S7B, the leftward space recognition device S7L, and the rightward space recognition device S7R has, for example, a viewing angle of about 180 degrees in a top plan view.

Also, the controller 30 maintains a correspondence relationship between: the detection ranges of the rearward space recognition device S7B, the leftward space recognition device S7L, and the rightward space recognition device S7R; and the photographing ranges of the rear camera S6B, the left camera S6L, and the right camera S6R. That is, when an object is detected by the rearward space recognition device S7B, the leftward space recognition device S7L, or the rightward space recognition device S7R, a region in which this object exists can be recognized from the photographed image data obtained by the corresponding rear camera S6B, left camera S6L, or right camera S6R.

The controller 30A according to the present embodiment is different from the controller 30 according to the above-described embodiment in that the controller 30A uses a detection result of the space recognition device S7 to identify a coordinate region and a frame size, in which a human or a work machine exists.

The controller 30A according to the present embodiment estimates the position and the size of the human or the work machine in real space in accordance with the detection result of the space recognition device S7. A method of estimating, from the detection result, the position at which the human or the work machine exists and the size of the human or the work machine may be a well-known method, and, for example, a trained model may be used. For example, the controller 30A may receive the position at which the human or the work machine exists and the size of the human or the work machine, by inputting the detection result of the space recognition device S7 to the trained model.

Then, the controller 30A converts the received position and size in real space into a coordinate region and a frame size in the photographed image data. This conversion is performed in accordance with the above-described correspondence relationship, and thus description thereof will be omitted.

The controller 30A performs the same control as in the above-described embodiment after obtaining the coordinate region and the frame size, in which the human or the work machine exists. That is, the first display device D3 displays, on the photographed image data, a frame indicating the object detected by the space recognition device S7 such that the frame overlaps with the photographed image data.

When the operation receiving part 304 receives, from an operator, an operation to suppress detection of the object, the setting part 305 registers, in the object storage database D4A, the detection data indicating the detection result of the object detected by the space recognition device S7 (e.g., the position and the size in real space) as the setting for suppression of the detection of the object.

Subsequently, when the controller 30A has estimated the position and the size of the human or the work machine in real space in accordance with the detection data of the space recognition device S7, the determination part 306 determines whether or not the position and the size of the human or the work machine are similar to detection data registered in the object storage database D4A by a predetermined threshold or more.

If the controller 30A determines that the position and the size of the human or the work machine estimated in accordance with the detection data of the space recognition device S7 are similar to detection data registered in the object storage database D4A by a predetermined threshold or more, the first display device D3 suppresses display of the frame indicating the human or the work machine. Also, the controller 30A may suppress safety control in accordance with the human or the work machine.

In the present embodiment, when the space recognition device S7 is used, the same effects as those of the above-described embodiment can be obtained. That is, when the detection result of the space recognition device S7 is used, inconvenience caused to the operator can be suppressed, and thus convenience can be improved. Further, when an object is falsely detected by the space recognition device S7, the false detection can be corrected, and thus detection accuracy can be improved.

The present embodiment illustrates a case in which the detection data is used as an example of the information indicating the object, while the one embodiment illustrates a case in which the image data is used as an example of the information indicating the object. However, the above-described embodiment does not limit the information indicating the object to the detection data or the image data, and the information indicating the object may be any information that identifies the object. For example, information about a feature or the like of the object may be used as the information indicating the object.

### Yet Another Embodiment

The above-described embodiment has been described based on an example in which the processing is performed only by the excavator 100 in which the operator is riding. However, the above-described embodiment does not limit the processing to the method of performing the processing only by the excavator 100. For example, a management server connected to the excavator 100 may perform the processing. Therefore, in the yet another embodiment, description will be given of a case in which the processing is performed by a system configured by the excavator 100 and a management server configured to manage the excavator 100.

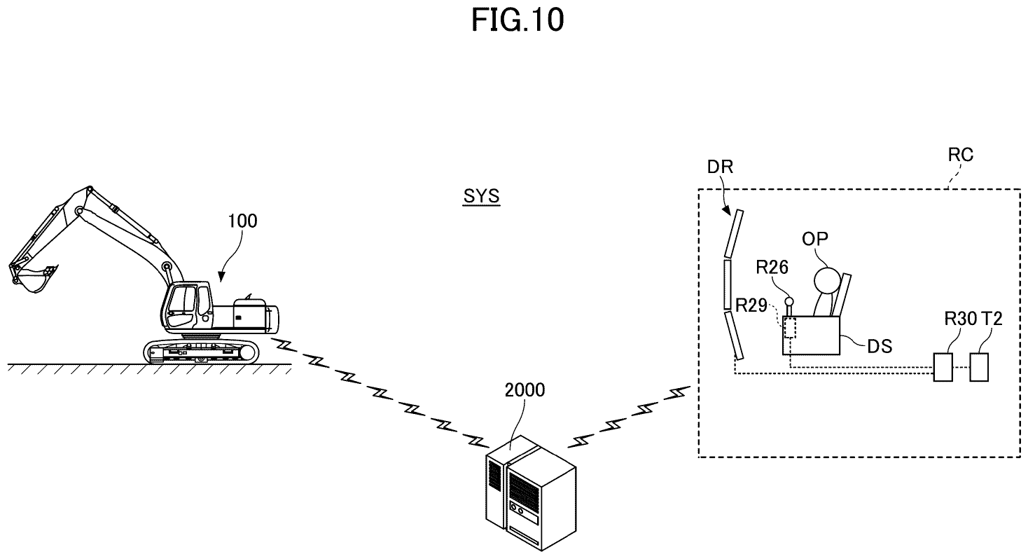

An outline of an excavator control system SYS according to the yet another embodiment will be described with reference to FIG. 10. FIG. 10 is a schematic view illustrating an example of the excavator control system SYS according to the yet another embodiment.

As illustrated in FIG. 10, the excavator control system SYS according to the yet another embodiment includes the excavator 100, a management server 2000, and a remote operation room RC.

The excavator 100 according to the present embodiment may be operated by an operator in the cab 10 or may be operated by an operator OP in the remote operation room RC.

### Configuration Example of Remote Operation Room

The remote operation room RC includes a communication device T2, a remote controller R30, an operation device R26, an operation sensor R29, and a display device DR. Also, the remote operation room RC includes an operation seat DS for the operator OP who is to perform remote operation of the excavator 100.

The communication device T2 is configured to control communication with the communication device T1 attached to the excavator 100.

The remote controller (an example of the remote control device) R30 is a calculation device configured to perform various calculations. In the present embodiment, the remote controller R30 is configured by a microcomputer including a CPU and a memory. Various functions of the remote controller R30 are achieved by the CPU executing programs stored in the memory.

The display device DR is configured to display a screen in accordance with the information transmitted from the excavator 100 in order for the operator OP in the remote operation room RC to visually recognize the surroundings of the excavator 100. The display device DR can confirm the situation of the work site including the surroundings of the excavator 100 even though the operator is in the remote operation room RC.

Further, the display device DR displays photographed image data in which a human or a work machine is enclosed by a frame, similar to the display screen 41 of the one embodiment illustrated in FIG. 5.

The operation device R26 is provided with the operation sensor R29 configured to detect operation contents of the operation device R26. The operation sensor R29 is, for example, a tilt sensor configured to detect the tilt angle of an operation lever, or an angle sensor configured to detect the pivot angle of an operation lever around the pivot axis. The operation sensor R29 may include another sensor, such as a pressure sensor, a current sensor, a voltage sensor, a distance sensor, or the like. The operation sensor R29 outputs information about the detected operation contents of the operation device R26 to the remote controller R30. The remote controller R30 generates an operation signal in accordance with the received information, and transmits the generated operation signal to the excavator 100. The operation sensor R29 may be configured to generate an operation signal. In this case, the operation sensor R29 may output an operation signal to the communication device T2 without going through the remote controller R30. Thus, the remote operation of the excavator 100 can be achieved from the remote operation room RC.

The communication device T1 of the excavator 100 receives an operation signal from the communication device T2 of the remote controller R30. The controller 30 of the excavator 100 performs various operations at the work site in accordance with the received operation signal.

### Control Regarding Management Server

The excavator 100 transmits detection results from various sensors provided to the excavator 100 to the management server 2000, by using the communication device T1 provided to the excavator 100. For example, the excavator 100 transmits photographed image data obtained by the photographing device S6 to the management server 2000. When the excavator 100 is provided with the space recognition device S7, the detection result of the space recognition device S7 is transmitted to the management server 2000.

The management server 2000 according to the present embodiment has the same configuration as the controller 30 in the above-described embodiment, and stores the trained model LM and the object storage database D4A.

Therefore, when the management server 2000 receives the photographed image data from the excavator 100, the management server 2000 receives a coordinate region and a frame size of a human or a work machine existing around the excavator 100 by inputting the received photographed image data into the trained model LM.

When the excavator 100 is operated by an operator, the management server 2000 transmits the coordinate region and the frame size of the human or the work machine to the communication device T1 of the excavator 100.

Also, when the excavator 100 is operated from the remote operation room RC, the management server 2000 transmits the coordinate region and the frame size of the human or the work machine to the communication device T2 in the remote operation room RC.

Thus, the first display device D3 of the excavator 100 or the display device DR in the remote operation room RC can display the human or the work machine included in the photographed image data enclosed by a frame.

Further, the management server 2000 also performs control for correcting the detection result, as in the above-described embodiment.

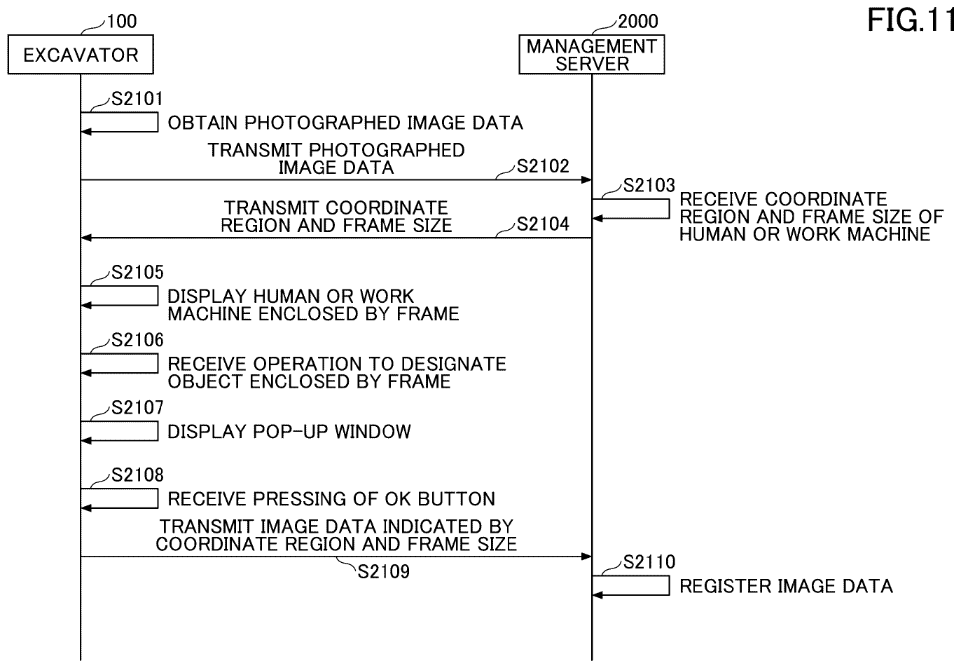

FIG. 11 is a sequence diagram illustrating a setting procedure for suppressing detection of an object in the excavator control system SYS according to the present embodiment. The example illustrated in FIG. 11 describes a case in which an operator in the cab 10 performs an operation. When the operator OP in the remote operation room RC performs an operation, the same control is performed except that the destination of the information transmitted from the management server 2000 is different, and thus description thereof will be omitted. The sequence diagram illustrated in FIG. 11 is assumed to be a sequence diagram in a case in which no image data is registered in the object storage database D4A.

First, the controller 30 of the excavator 100 obtains photographed image data obtained by the photographing device S6 (S2101).

Then, the controller 30 transmits the obtained photographed image data to the management server 2000 via the communication device T1 (S2102).

By inputting the received photographed image data into the trained model LM, the management server 2000 receives a coordinate region and a frame size, in which a human or a work machine exists around the excavator 100 (S2103).

The management server 2000 transmits the received coordinate region and frame size to the communication device T1 of the excavator 100 (S2104).

The first display device D3 of the excavator 100 displays the photographed image data, along with the detected human or work machine enclosed by a frame in accordance with the received coordinate region and frame size (S2105).

The controller 30 of the excavator 100 receives an operation to designate the object enclosed by the frame in the first image display section 41n1 or the second image display section 41n2 via the touch panel of the input device D2 (S2106).

When the first display device D3 receives the operation to designate the object, the first display device D3 displays a pop-up window for confirming suppression of detection of the object (S2107). The pop-up window is similar to that illustrated in (b) of FIG. 6, and thus description thereof will be omitted.

The controller 30 of the excavator 100 receives pressing of the OK button of the pop-up window via the touch panel of the input device D2 (S2108).

When the controller 30 receives pressing of the OK button, the controller 30 transmits image data indicated by the coordinate region and the frame size of the object to the management server 2000 (S2109).

The management server 2000 registers the received image data in the object storage database D4A (S2110).

When the image data is registered in the object storage database D4A in accordance with the above-described processing, a determination using the object storage database D4A is performed.

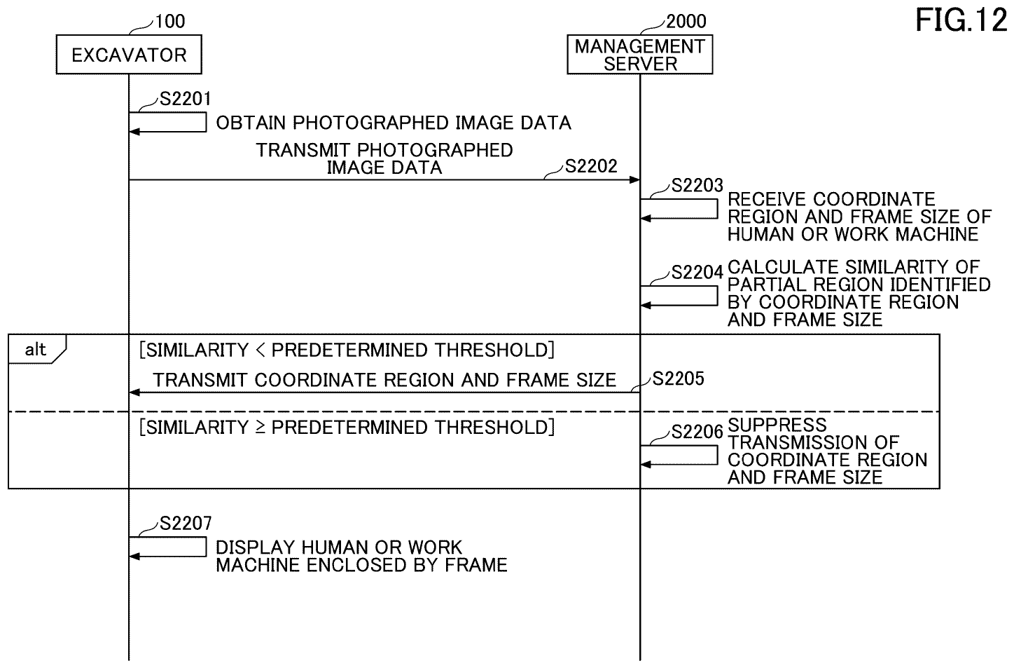

FIG. 12 is a sequence diagram illustrating a processing procedure in a case of performing a determination using the object storage database D4A when the excavator control system SYS according to the present embodiment displays the photographed image data.

First, the controller 30 of the excavator 100 obtains photographed image data obtained by the photographing device S6 (S2201).

Then, the controller 30 transmits the obtained photographed image data to the management server 2000 via the communication device T1 (S2202).

By inputting the received photographed image data into the trained model LM, the management server 2000 receives a coordinate region and a frame size, in which a human or a work machine exists around the excavator 100 (S2203).

The management server 2000 calculates similarity between a partial region of the photographed image data identified in accordance with the received coordinate region and frame size, and image data registered in the object storage database D4A (S2204).

If the management server 2000 determines that the similarity is less than a predetermined threshold, the management server 2000 transmits the received coordinate region and frame size to the communication device Tl of the excavator 100 (S2205).

On the other hand, if the management server 2000 determines that the similarity is a predetermined threshold or more, the management server 2000 suppresses transmission of the received coordinate region and frame size to the communication device T1 of the excavator 100 (S2206).

In the present embodiment, when there are a plurality of coordinate regions and frame sizes received from the trained model LM, the management server 2000 repeats the process of S2204 through S2206 a number of times equal to the number of coordinate regions and frame sizes.

Then, the first display device D3 of the excavator 100 displays the photographed image data, along with the human or the work machine enclosed by a frame in accordance with the received coordinate region and frame size (S2207).

In the present embodiment, the excavator control system SYS may include one or more excavators 100. Thus, when the excavator control system SYS registers image data whose false detection is to be suppressed in accordance with an operation from one excavator 100, false detection is suppressed in the other excavators 100. That is, false detection is suppressed in the other excavators 100 without any operation, and thus it is possible to improve detection accuracy and work efficiency.

### Effects

According to the above-described embodiments, the controller 30 or 30A, the first display device D3, or the management server 2000 suppresses false detection of an object in accordance with the above-described control. Thus, it is possible to improve detection accuracy. Also, there is no need to provide a new sensor configured to suppress false detection, so it is possible to suppress an increase in cost.

Further, according to the above-described embodiments, display of a frame due to false detection is suppressed. Thus, it is possible to suppress inconvenience when an operator refers to a display screen, thereby improving convenience.

Although the embodiments of the excavator and the excavator control system according to the present disclosure have been described above, the present disclosure is not limited to the above-described embodiments. Various changes, modifications, substitutions, additions, deletions, and combinations are possible within the scope of the claims recited. These also fall within the technical scope of the present disclosure.

What is claimed is:

1. An excavator, comprising:
a lower traveling body;
an upper slewing body that is slewably mounted on the lower traveling body;
a photographing device that is attached to the upper slewing body;
a display device configured to display photographed image data that is obtained by the photographing device; and
a control device configured to, in response to receiving an operation to designate an object included in the photographed image data, perform, on information indicating the object, a setting to suppress detection of the object.

2. The excavator according to claim 1, wherein
the setting to suppress the detection of the object is performed in accordance with the operation that is received for a period during which the excavator is in operation.

3. The excavator according to claim 1, wherein
the display device is configured to display, on the photographed image data, display information indicating the object detected, and
the control device is configured to, in response to receiving the operation to designate the object indicated by the display information, perform, on the information indicating the object, the setting to suppress the detection of the object.

4. The excavator according to claim 3, wherein
the display device is configured to, in response to detecting the object indicated by the information on which the setting for suppression of the detection of the object is performed, suppress display of the display information indicating the object.

5. The excavator according to claim 4, wherein
the control device is configured to
perform, on image data including the object, the setting to suppress the detection of the object, and
suppress the display of the display information indicating the object in a case in which a partial region of the photographed image data obtained by the photographing device is similar, by a predetermined threshold or more, to the image data on which the setting is performed.

6. The excavator according to claim 4, further comprising:
a space recognition device that is attached to the upper slewing body, wherein
the display device is configured to display, on the photographed image data, the display information indicating the object detected by the space recognition device, and
the control device is configured to
perform, on detection data indicating a result of detection of the object detected by the space recognition device, the setting to suppress the detection of the object, and
suppress the display of the display information indicating the object, in a case in which a detection result obtained by the space recognition device is similar, by a predetermined threshold or more, to the detection data on which the setting is performed.

7. The excavator according to claim 1, further comprising:
a touch panel configured to receive an operation indicating positional coordinates in the photographed image data displayed on the display device, wherein
the control device is configured to receive, via the touch panel, the operation to designate the object included in the photographed image data.

8. An excavator control system, comprising:
an excavator including a lower traveling body, an upper slewing body that is slewably mounted on the lower traveling body, and a photographing device that is attached to the upper slewing body;
a display device configured to display a photographed image that is obtained by the photographing device; and
a control device configured to, in response to receiving an operation to designate an object included in the photographed image, perform, on information indicating the object, a setting to suppress detection of the object.
